(19) United States
(12) Patent Application Publication
(10) Pub. No.: US 2023/0017129 A1
(43) Pub. Date: Jan. 19, 2023

(54) PRINTING WITH OFFSET PRINT ELEMENTS

(71) Applicant: HEWLETT-PACKARD DEVELOPMENT COMPANY, L.P., Spring, TX (US)

(72) Inventors: Rachelle Heather Castilloux COBB, Vancouver, WA (US); Daniel Ethan Frantz QUARTO, Vancouver, WA (US); Kelvin James MCDONALD, Vancouver, WA (US); Quan An THAI, Vancouver, WA (US)

(21) Appl. No.: 17/783,195

(22) PCT Filed: Dec. 20, 2019
(86) PCT No.: PCT/US2019/068017

§ 371 Date: Jun. 7, 2022

(51) Int. Cl. B41J 2/21; B41J 2/045

(52) U.S. Cl. CPC B41J 2/2103; B41J 2/04541; B41J 2/04586

(57) ABSTRACT

An example device includes a printhead including a first print element to print a first color to a print medium and a second print element to print a second color to the print medium. The second print element is spaced apart from the first print element by an offset distance. The device further includes a controller communicatively coupled to the printhead. The controller is to control the printhead to print an image, and in response to receiving a signal to stop printing the image, control the first print element to stop printing the first color to the print medium and control the second print element to continue printing the second color to the print medium.

### BACKGROUND

Printers are used to create physical representations of data. A printer may be used to mark a medium, such as a sheet of paper, with an image. Examples of printers include toner-based printers, such as laser printers, inkjet printers, solid ink printers, dye-sublimation printers, and thermal printers.

### BRIEF DESCRIPTION OF THE DRAWINGS

FIG. 1 is a schematic diagram of an example device including a printhead that is controlled to stop printing a first color while continuing to print a second color.

FIG. 2 is a flowchart of an example method of independently stopping print elements from printing.

FIGS. 3A-3D are schematic diagrams of an example device independently stopping print elements from printing.

FIG. 4 is a schematic cross-sectional diagram of an example device including a printhead within a moveable housing, the printhead to sequentially stop printing with offset print elements according to an encoder at the housing.

FIGS. 5A-5C are schematic diagrams of an example user interface and an example device to independently stop print elements from printing.

### DETAILED DESCRIPTION

Some types of printers, such as handheld printers, allow printing to be stopped after an indeterminate size of image has been printed. For example, a handled printer may be manually drawn across a sheet of paper until the user wishes to stop. The users action or intention ends the print instead of the exhaustion of the print data. To facilitate such printing, it is often the case that print data is repeated or that the character of the print data is otherwise suitable for printing an indeterminate size of image.

A printer may include multiple print elements, such as different sets of inkjet nozzles for different colors of ink. The print elements may be physically offset from one another. As such, when stopping the printing of an image having an indeterminate size, the edge of the image may be incomplete. For example, the multiple print elements may each print a different color and stopping printing at an arbitrary location may result in patches of unmixed colors in the printed image.

When a user wishes to stop printing at a particular location, the printer may stop the print elements in sequence while still moving, so that the print elements stop printing at the same location on the print medium. For example, an arrangement of rows of nozzles for different colors of ink may be commanded to stop ejection of ink, as each row arrives at the desired stop location, so that the printed image includes all color components up to the stop location. In the example of a handheld printer, the user moves the printer for a short distance after wishing to stop printing, so as to give each colors nozzles sufficient time to reach the stop location. Thus, an incomplete edge of an image may be avoided and the appearance of a printed image of indeterminate length may be provided as expected.

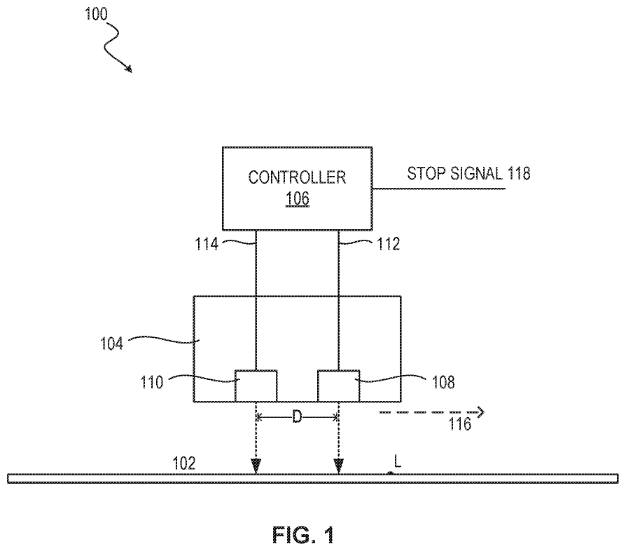

FIG. 1 shows an example device 100. The device 100 may be a printer or a component of a printer; such as a handheld printer that is manipulated to move across a print medium 102 (e.g., a sheet of paper).

The device 100 includes a printhead 104 and a controller 106 communicatively coupled to the printhead 104. The printhead 104 and controller 106 may be physically connected, such as being installed in the same housing and connected by electrical conductors. The controller 106 may be part of a printhead assembly that includes the printhead 104. In other examples, printhead 104 and controller 106 may be separate and communicate wirelessly.

The printhead 104 includes a first print element 108 and a second print element 110 to provide different marks to the print medium 102. Marks may be different in terms of color, intensity, or other characteristic, A mark may be made by applying heat energy to the print medium, by depositing a print agent to the print medium, or by applying a similar technique. Inkjet printheads are discussed as examples herein with marks being made by different colors of ink droplets. It is contemplated that other types of print elements or printing fluids or materials may be used. For example, solid-ink or laser print elements may be controlled as described herein provided that there is a physical offset distance between print elements with respect to a print medium. Furthermore, stationary systems with scanning elements may be used as well as portable or mobile systems that are moved across a page.

Any suitable quantity of print elements 108, 110 may be provided, such as two, three, five, eight, and so on.

Examples of print agents include inks of different colors. For example, four print elements may be provided, one for each of cyan, magenta, yellow, and black (CMYK) ink. In another example, three print elements may be provided, one for each of cyan, magenta, and yellow (CMY) ink. In still other examples, other color models may be used with a corresponding number of print elements. Further, although it is contemplated that print elements and colors have a one-to-one relationship, the techniques described herein may be applied to implementations where multiple print elements print the same color or where a particular print element prints multiple colors. In addition, as mentioned above, color is an example image characteristic that is provided by different spatially offset print elements. It is contemplated that other characteristics may be provided by different spatially offset print elements.

The print elements 108, 110 are independently controllable by the controller 106. In this example, the first print element 108 is communicatively connected to the controller 106 by a first conductive trace or wire 112 and the second print element is communicatively connected to the controller 106 by a second conductive trace or wire 114.

In this example, the first print element 108 prints a first color to the print medium 102 and the second print element 110 prints a second color to the print medium 102. Printing occurs during relative movement, indicated by axis 116, of the printhead 104 and the print medium 102, so that print data, such as image data, is gradually printed to a region of the print medium 102. The printhead 104 may move and the medium 102 may remain stationary, the medium 102 may move and the printhead 104 may remain stationary, or both the printhead 104 and medium 102 may move. Further, movement may occur in multiple dimensions. For example, the printhead 104 may scan back and/or forth along the axis 116 and/or while a carriage that carries the printhead 104 may be moved in a perpendicular direction (i.e., into and/or out of the page of FIG. 1). In this example, the printhead 104 is moved relative to the stationary medium 102.

The print elements 108, 110 are spaced apart from one another by an offset distance D. The offset distance D may be parallel to the axis 116 of movement of the printhead 104. The offset distance D may be entirely parallel to the axis 116 of movement. That is, the print elements 108, 110 may be offset linearly along the same axis 116 as printhead movement. In other examples, the offset distance D may have a component that is parallel to the axis 116 of movement. That is, the print elements 108, 110 may be offset from each other in two dimensions in a common plane, where the plane is parallel to the axis 116 of movement of the printhead 104.

The controller 106 may include a microcontroller, a microprocessor, a processing core, a processor, a field-programmable gate array (FPGA), an application-specific integrated circuit (ASIC), a central processing unit (CPU), or a similar device capable of executing instructions. The controller 106 may cooperate with a non-transitory machine-readable medium that may be an electronic, magnetic, optical, or other physical storage device that encodes executable instructions. The machine-readable medium may include, for example, random access memory (RAM), read-only memory (ROM), memory, a storage drive, an optical device, or similar.

The controller 106 controls the printhead 104 to print an image. The controller 106 may provide driving signals to the first and second print elements 108, 110 in accordance with print data. As the printhead 104 moves relative to the print medium 102, the first print element 108 will create a mark of the first color on the medium at a location L and subsequently the second print element 110 will create a mark of the second color at the same location L. This may occur for a continuous array of locations of pitch of hundreds or more dots per inch (DPI). In this way, the first and second colors may be provided individually and as mixed on the medium to form the image.

It is noted that “images,” as discussed herein, may include graphics, photographs, words, numbers, text, or other visual representations of print or image data. Further, the terms “print data” and “image data” are used interchangeably and may represent any information that may be printed, such as an image contained in a source document or file, raster or bitmap data, or similar data.

While an image is being printed, the controller 106 may receive a signal 118 that indicates that the image should stop being printed. For example, the image may be of indeterminate size and the stopping of printing may be a user decision or may be determined by another factor. Examples of images of indeterminate size include repeating patterns, tiled images, images of solid color, images of graduated color, images having a dimension larger than the print medium, and so on. For example, as the device 100 may be a handheld printer, it may be used to “draw” an image for an indeterminate length as the user moves the device 100 across the medium 102. For example, the image may be a repeating pattern and the user may wish to print a border to a scrapbook page.

In response to receiving a signal 118 to stop printing the image, the controller 106 controls the first print element 108 to stop printing the first color to the print medium 102, while controlling the second print element 110 to continue to print the second color to the print medium 102 according to the image data. That is, if the stop signal 118 is received when the first print element 108 is at a location L, the first print element 108 stops printing and the second print element 110 continues to print as the printhead 104 is moved towards the same location L. Location L thereby becomes an end-of-print location and is set by the user or other source that provided the stop signal.

After the printhead 104 moves sufficiently to bring the second print element 110 to the location L, that is after the printhead 104 has moved the offset distance D relative to the print medium 102, the controller 106 controls the second print element 110 to stop printing the second color. As such, printing of both the first and second colors terminates at the same location on the print medium, despite the offset distance D between the first and second print elements 108, 110.

An image printed by the controller 106 in this way appears complete in the sense that the contributing colors are printed up the same location. The controller 106 does not stop the printing of all colors at the same time. Rather, the controller 106 interprets the stop signal 118 and the movement of the printhead 104 relative to the medium 102 and stops each print element 108, 110 at different times as each print element 108, 110 arrives at the same location. In other words, the controller 106 determines a stop location from the stop signal 118 and continues to print up to that location.

As such, patches of incomplete image may be avoided and the edge of the image where printing stopped may appear distinct or clear.

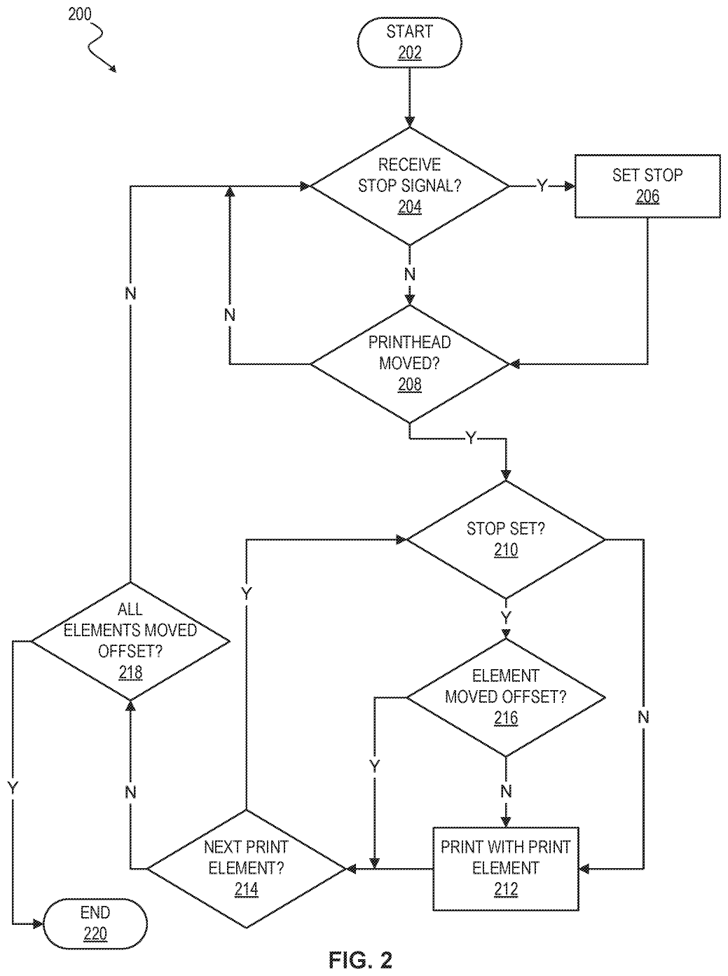

FIG. 2 shows a method 200 that independently stops print elements that are separated by an offset distance. The method 200 may be performed by the devices discussed herein. The method 200 may be implemented by machine-readable instructions. The method begins at block 202.

At block 204, it is determined whether a stop signal is received. A stop signal may include a user input to stop printing or a similar input from another source.

If the stop signal is received, then a stop is set, at block 206. Setting the stop may include determining a location of a leading print element along the print medium when the stop signal was received. The location may be used to detect sufficient travel of a print element or elements that follow the leading print element. The location may be considered a stop location, at which printing is to cease. The stop location may be determined from an encoder that measures relative movement of the print elements to the print medium.

At block 208, if the printhead have moved relative to the print medium, printing occurs. If not, then printing does not occur. In the example of a handheld printer, an encoder may be used to determine that the printer is being swept across the medium. If the printer does not move, then printing may be temporarily paused.

When printing is to occur, it is determined whether the stop has been set, at block 210. If the stop has not been set, then each print element is driven to mark the print medium, via blocks 212, 214. These markings by the print elements occur at different locations on the print medium due to a physical offset between print elements.

If the stop has been set, then prior to driving a given print element, it is determined whether the print element has moved its offset distance, at block 216. That is, moving less than the offset distance from the location where the stop was set is a condition to print with the print element. Once the print head has moved the offset distance, it is no longer driven to mark the medium.

At block 218, after all print elements have been driven to make a mark or not, it is determined whether each print element has moved its respective offset distance. If a print element has not yet moved its offset distance, then the method 200 repeats. If all print elements have oved sufficiently, then the method ends at block 220 as printing has been stopped. As such, printing by different printheads may be consistently ended at the same arbitrarily selected stop location on a print medium.

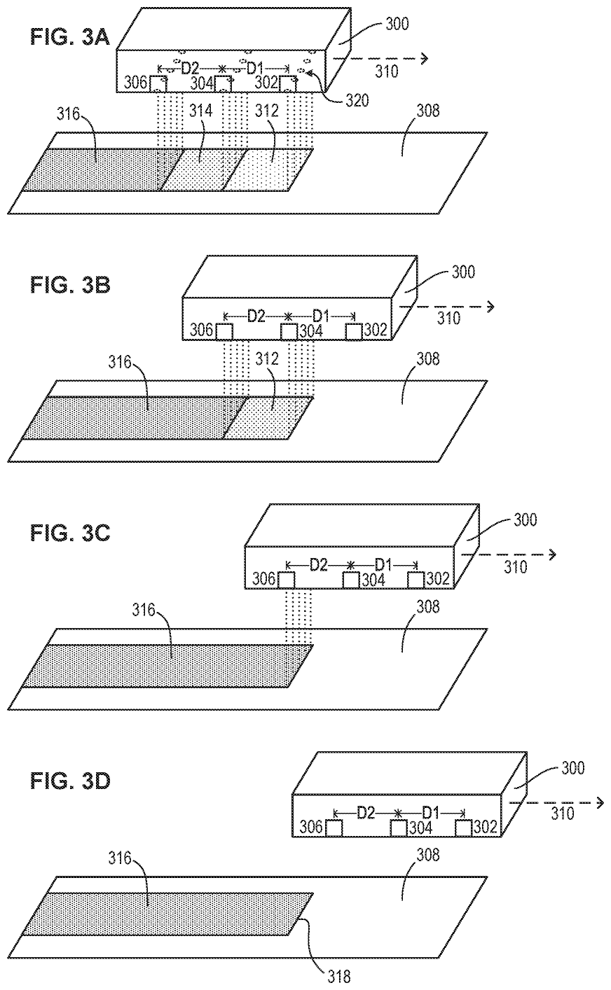

FIGS. 3A-3D show an example printhead 300. The printhead 300 may be similar to other printheads described herein, and the description of the other printheads may be referenced for details not repeated here, with like reference numerals and like terminology denoting like components. The printhead 300 includes a plurality of print elements 302, 304, 306 at different example locations during the printing of an image. A first print element 302 leads printing as the printhead 300 moves with respect to a print medium 308 along an axis 310 of movement. A second print element 304 follows the first print element 302 by a first offset distance D1. A third print element 306 follows the second print element 306 by a second offset distance D2. Each print element 302, 304, 306 may include an array of inject nozzles, such as row 320 for print element 302, as shown in FIG. 3A.

It is noted that offset distance may be determined using various reference points. In this example, offset distances are between adjacent print elements. In other examples, offset distances may be with respect to one of the print elements (e.g., offset distance D2 could extend between the first and third print elements 302, 306, so that the first print element 302 is a common reference point). In various examples, a reference point for an offset distance may be any location on the printhead 300, such as the location of a print element or another location on the printhead 300. In still other examples, a reference point for an offset distance may be a location on another component that moves with the printhead 300.

In FIG. 3A, the first print element 302 has marked a first region 312 that has not yet been marked by the second and third print elements 304, 306. The second print element 304 has marked a second region 314 that has previously been marked by the first print element 302 but that has not yet been marked by the third print element 306. The third print element 306 has marked a third region 316 that has previously been marked by the first and second print elements 302, 304, thereby completing the image in this region 316. At this point, a stop signal is provided from an external source, such as a user interface. If all the print elements 302, 304, 306 were stopped at this time, the image would have an unfinished appearance due to partially printed regions 312, 314 contrasting with each other and with the completed region 316. As such, the stop signal controls the first print element 302 to stop printing while the second and third print element 304, 306 continue printing.

As shown in FIG. 3B, the printhead 300 continues to move along the axis 310 after the first print element 302 stops printing. The second print element 304 prints to the first region 312, and the third print element 306 prints to the second region 314 thereby extending the completed region 316. At the position shown, the printhead 300 has just moved the first offset distance D1 and consequently the second print element 304 is controlled to stop printing. The third print element 306 is controlled to continue printing.

As shown in FIG. 3C, the printhead 300 continues to move along the axis 310 after the first and second print elements 302, 304 stop printing. The third print element 306 prints to the first region 312 thereby extending the completed region 316. At the position shown, the printhead 300 has just moved the second offset distance D2 and consequently the third print element 306 is controlled to stop printing.

FIG. 3D shows the printhead 300 continuing to move with all print elements 302, 304, 306 not printing. The printed region 316 is complete and has a clean edge 318 defined by the location where all print elements 302, 304, 306 stopped printing.

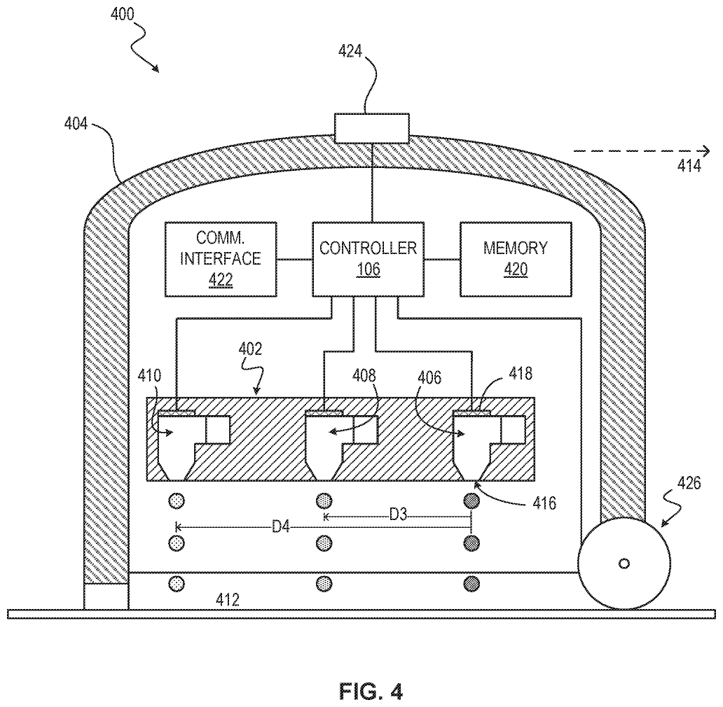

FIG. 4 shows an example device 400 including a printhead 402 and a controller 106 disposed within a moveable housing 404. The controller 106 controls the printhead 402 to sequentially stop printing with its offset print elements 406, 408, 410 to provide a clean edge to a printed image of indeterminate size. The device 400 may be similar to other devices described herein. The description of the other devices may be referenced for details not repeated here, with like reference numerals and like terminology denoting like components.

The housing 404 holds the printhead 402 and the controller 106. The housing 404 may be shaped and sized to be manually moved by a user across a print medium 412, such as a sheet of paper, along an axis 414 of movement that lies within a plane defined by the print medium 412.

The print elements 406, 408 410 are offset from one another along the axis 414. For example, print elements 408 and 410 may be offset from a print element 406 by respective distances D3 and 04.

Each print element 406, 408 410 may include an array of inkjet nozzles 416. A nozzle 416 may be fed by an ink channel and/or reservoir. A driving element 418, such as a heater or piezoelectric device, may be positioned at the nozzle 416 to eject droplets of ink through the nozzle 416. Driving elements 418 may be connected to the controller 106.

The device 400 may further include memory 420 connected to the controller 106. The memory 420 may store instructions executable by the controller 106 to perform the functionality discussed herein. The memory 420 may also store the offset distances D3, D4 and an indication of whether the stopping of printing has been commanded.

The device 400 may further include a communications interface 422 connected to the controller 106. The communications interface 422 may provide for wired and/or wireless communications with a computing device, such as a notebook computer, smartphone, or the like. Example communications interfaces include a wireless network adaptor (e.g., Wi-Fi, Bluetooth™, etc.), a near-field communications (NFC) adaptor, a serial port, and the like. Print data may be communicated to the device 400 via the communications interface 422.

The device 400 may further include a user interface 424, such as a button, in communication with the controller 106. The user interface 424 may communicate a stop signal to the controller 106 to indicate that printing is to be stopped. For example, a user may press (or release) the button to generate the stop signal to indicate that printing is to be stopped. In another example, a user interface is provided at a computing device connected via the communications interface 422, so that a stop signal may be triggered via the communications interface 422. For example, a user may indicate that printing is to be stopped through an application on a smartphone that wirelessly communicates with the communications interface 422. In still other examples, other types of switches or instructions may be used to generate a stop signal.

The device 400 further includes an encoder 426 connected to the controller 106. The encoder 426 may determine the movement of the device 400 relative to the print medium 412 along the axis 414. The encoder 426 may include a rotary encoder connected to a wheel that rolls along the print medium 412. The encoder 426 may include an optical encoder that captures images of the print medium 412 and determines movement by analyzing captured images. In other examples, other types of encoders may be used to measure movement of the device 400 relative to the print medium 412.

The controller 106 controls the print elements 406, 408, 410 to mark the print medium 412 for an arbitrary length along the print medium 412. The user may grip the housing 404 and move the device 400 along the print medium 412 until deciding to stop. When the user wishes to stop, the user actuates the user interface 424 (e.g., presses a button) to command the device 400 to communicate a stop signal to the controller 106.

In response to receiving the stop signal, the controller 106 commands the print elements 406, 408, 410 to sequentially stop printing as each respective offset distance is traveled, as indicated by the encoder 426. The leading print element 406, that is the print element positioned at the furthest extent in the direction of movement, may be stopped immediately upon receiving the stop signal (e.g., as if its offset distance were zero). Following print elements 408, 410 are subsequently stopped when the respective offset distance D3, D4 is reached.

In the example depicted, the print element 406 leads in the direction of movement indicated at axis 414. In other examples, the print element 410 may lead when the movement is opposite. The controller 106 may detect the direction of movement based on a signal received from the encoder 426, so that the sequence of controlled stopping of printing at the print elements 406, 408, 410 may be determined at time of use. That is, the device 400 may be operable in opposite directions along axis 414 and, as such, the sequence of stopping the print elements may start at print element 406 or 410 depending on the direction of movement detected.

The user interface 424, whether located on the device 400 or presented at a communicating device, may assist the user in understanding that the device 400 should be moved some distance after wishing to stop printing. A user instruction may be issued by the device 400 to inform the user that the device 400 may be stopped. For example, the user interface 424 may include a speaker or vibrator that the controller 106 commands to emit a sound or vibration after the last print element has moved its offset distance. In another example, the user interface 424 may include a display that visually informs the user when movement should be stopped.

A user instruction may be issued by the device 400 to instruct the user to continue to move the device after the used has commanded the device 400 to stop printing. For example, a smartphone application may instruct the user to continue moving the device 400 a short distance after receiving an input to stop printing.

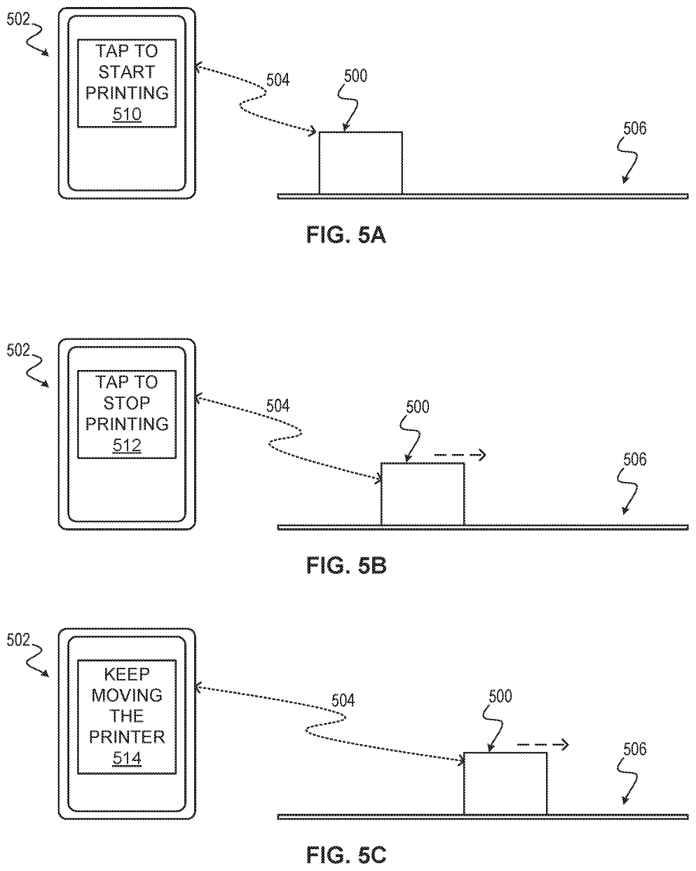

FIGS. 5A-5C show an example printing device 500 with a user interface presented at a computing device 502, such as a smartphone. The device 500 may be similar to other devices described herein, and the description of the other devices may be referenced for details not repeated here, with like reference numerals and like terminology denoting like components.

The printing device 500 may be manually moved by a user over a print medium 506 to mark the print medium 506. The printing device 500 may be fully or partially controlled by an application executed at the computing device 502 and in communication with a controller of the printing device 500 via a wireless signal 504.

The application may present a user interface at the computing device 502. As shown in FIG. 5A, the user interface may include a start element 510, such as a virtual button, to start printing with the printing device 500. As shown in FIG. 5B, the user interface may include a stop element 512, such as a virtual button, to stop printing with the printing device 500. The stop button 512 may cause a stop signal to be transmitted from the computing device 502 to the printing device 500. In response to the stop signal, the printing device 500 may begin sequentially stopping its print elements from printing, as the device 500 continues to move. As shown in FIG. 50, the user interface may include an instruction element 514, such as message box, to instruct the user to continue moving the printing device 500 a short distance while the print elements sequentially stop printing, as discussed elsewhere herein.

It should be apparent from the above that a printed image may be provided with all of its components, as provided by physically separated print elements, up to a stop location. A handheld printer may be moved a short distance after a user wishes to stop printing, so as to allow each print element to reach the stop location. Thus, an incomplete edge of an image may be avoided and the appearance of a printed image of indeterminate length may be provided as expected.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a printhead including a first print element to print a first color to a print medium and a second print element to print a second color to the print medium, the second print element being spaced apart from the first print element by an offset distance; and
a controller communicatively coupled to the printhead to:
control the printhead to print an image; and
in response to receiving a signal to stop printing the image, control the first print element to stop printing the first color to the print medium and control the second print element to continue printing the second color to the print medium.

2. The device of claim 1, wherein the controller is further to control the second print element to stop printing the second color to the print medium after the printhead moves the offset distance relative to the print medium.

3. The device of claim 2, further comprising an encoder connected to the controller, the encoder to determine that the printhead has moved the offset distance relative to the print medium.

4. The device of claim 3, further comprising a housing to hold the printhead and the controller, the housing to be manually moved with respect to the print medium, wherein the encoder is to determine movement of the housing relative to the print medium.

5. The device of claim 1, wherein the first print element comprises a first array of inkjet nozzles and wherein the second print element comprises a second array of inkjet nozzles, wherein the second array of inkjet nozzles is spaced apart from the first array of inkjet nozzles by the offset distance along an axis of movement of the printhead relative to the print medium.

6. The device of claim 1, further comprising a button to generate the signal to stop printing the image.

7. A device comprising:
a printhead including a first print element and a second print element, the second print element being spaced apart from the first print element by an offset distance; and
a controller connected to the printhead to;
control the first print element and the second print element to mark a print medium to print an image of indeterminate size; and
in response to receiving a stop signal while printing the image of indeterminate size, control the first print element to stop marking the print medium and control the second print element to continue marking the print medium for the offset distance.

8. The device of claim 7, wherein the controller is further to control the second print element to stop marking the print medium in response to the printhead moving the offset distance.

9. The device of claim 7, further comprising an encoder connected to the controller, the encoder to measure movement of the printhead with respect to the print medium to determine that the printhead has moved the offset distance.

10. The device of claim 7, wherein the first print element includes a first inkjet nozzle to eject ink of a first color and the second print element includes a second inkjet nozzle to eject ink of a second color.

11. The device of claim 7, further comprising a user interface in communication with the controller, the user interface to provide the stop signal to the controller.

12. The device of claim 11, further comprising a housing to hold the printhead and the controller, wherein the user interface includes a button at the housing.

13. A non-transitory machine-readable medium comprising instructions to:
control spaced apart print elements to print to a medium; and
in response to receiving a stop signal:
stop printing with a lead print element of the spaced apart print elements; and
stop printing with a following print element of the spaced apart print elements after the following print element has traveled an offset distance between the lead print element and the following print element.

14. The non-transitory machine-readable medium of claim 13, wherein the lead print element and the following print element are separated by the offset distance along an axis of relative movement of the spaced apart print elements with respect to the medium.

15. The non-transitory machine-readable medium of claim 13, wherein the instructions are to:
control spaced apart print elements to print an image of indeterminate size to the medium; and
receive the stop signal from a user interface.
